(19) United States
(12) Patent Application Publication
(10) Pub. No.: US 2017/0051483 A1
(43) Pub. Date: Feb. 23, 2017

(54) MANUALLY CLEANABLE DRAIN TRAP

(71) Applicant: Gregory C. Dildilian, Royal Oak, MI (US)

(72) Inventor: Gregory C. Dildilian, Royal Oak, MI (US)

(21) Appl. No.: 15/239,182

(22) Filed: Aug. 17, 2016

Related U.S. Application Data
(60) Provisional application No. 62/205,771, filed on Aug. 17, 2015.

(51) Int. Cl. E03C 1/30; F16K 15/04; E03C 1/288

(52) U.S. Cl. CPC E03C 1/30; E03C 1/288; F16K 15/04

(57) ABSTRACT

A drain trap facilitates resilient compression of a flexible trap section while blocking the simultaneous reverse flow of water out of the fixture inlet drain. The trap section may be manually squeezed or otherwise manipulated to dislodge unwanted materials clogging the trap section. The wall thickness of the trap section may be thinned-down and/or composed of a rubber or rubber-like elastomer or other compressible material to facilitate squeezing of the trap section. A one-way or “check” valve disposed in the fluid inlet section permits fluid to flow into the fluid inlet section and through the trap section, while preventing back flow from the trap section and into the fluid inlet section as the trap section is manually squeezed. The one-way or check valve may be a ball valve. The trap section may include a non-smooth or textured outer surface to assist a user in gripping and squeezing the trap section.

### REFERENCE TO RELATED APPLICATION

This application claims priority from U.S. Provisional Patent Application Ser. No. 62/205,771, filed Aug. 17, 2015, the entire content of which is incorporated herein by reference.

### FIELD OF THE INVENTION

This invention relates generally to plumbing fixtures and, in particular, to a manually cleanable drain trap that is easy to clear without removal.

### BACKGROUND OF THE INVENTION

The outlets of plumbing fixtures such as sinks and toilets typically employ a bent section in the form of a U-, S-, or J-shaped pipe which retains a small amount of water after the fixture's use, so as to prevent sewer gases from exiting from the plumbing fixture outlet and entering the building in which the plumbing fixture is installed. These bent sections are commonly referred to as “traps.”

Since traps are the localized low point in the plumbing, heavy items or items that are difficult to fit through the plumbing outlet are often collected in the trap. These items may include hair, sand, debris, and the products of defecation. For this reason most traps can either be disassembled for cleaning or provide some sort of cleanout feature.

Drain traps for kitchen and bathroom sinks are typically located in cabinetry immediately below the sink. One proposed solution to avoiding disassembly to clean a plugged sink drain trap is to make the low point of the bend out of a manually compressible material, usually a plastic. One example is disclosed in U.S. Pat. No. 2,484,031, which describes a trap including a hollow receptacle of generally tubular shape, an inlet socket member and an outlet socket member. The receptacle is constructed of “an elastic plastic material” which is sufficiently resilient to yield to deformation by the hand so that slime and other matter precipitated inside the trap may be loosened therefrom by squeezing the receptacle by hand so as to temporarily deform the same.

U.S. Pat. No. 7,004,508 teaches a one-piece body with proximal and distal ends including a section “formed to be flexible” and to have a stiffness that is less than either the stiffness of the body adjacent to distal end or the stiffness of the body adjacent to proximal end. The varying stiffness of the section permits the body to be easily manipulated during installation or removal, but will also permit a blockage to be “easily cleared.”

With configurations of the type just described, when material collects in the bend, it can often be forced down the drainpipe by manually pressuring the flexible section to force the collected material down the pipe. However, these existing configurations are inefficient, since the applied compressive force pushes fluid out of the bend in both directions, returning some of water in the bend through the entrance of the plumbing fixture outlet rather than forcing all of the fluid and debris downstream.

### SUMMARY OF THE INVENTION

The present invention improves upon prior-art solutions by providing a drain trap that easily facilitates the compression of a flexible section while blocking the simultaneous reverse flow of water out of the fixture inlet drain.

A manually cleanable drain trap according to the invention includes a bent tubular structure comprising a fluid inlet section, a fluid outlet section, and a U-shaped trap section disposed between the fluid inlet and outlet sections. The construction of the trap section is such that it enables the trap section to be manually squeezed or otherwise manipulated to dislodge unwanted materials clogging the trap section. A one-way or “check” valve disposed in the fluid inlet section permits fluid to flow into the fluid inlet section and through the trap section, while preventing back flow from the trap section and into the fluid inlet section as the trap section is manually squeezed.

The construction of the trap section is resiliently flexible to facilitate manual manipulation of the trap section. In the preferred embodiment, at least the trap section is composed of a compressible, resilient material such as a rubber-like elastomer. The wall thickness of the trap section may also be thinned-down to support this manual manipulation. In all preferred embodiments, the inner wall of the trap section is smooth to reduce debris build-up in the first place. The outer surface of the trap section, however, may be non-smooth or indeed textured to assist a user in gripping and squeezing the trap section.

The one-way or check valve disposed in the fluid inlet section is preferably a ball valve, which may be disposed in a bulbous section formed in the fluid inlet portion. The ball housing further preferably includes a circular seat that the ball engages with under pressure to close the valve. The ball housing may also include an inner wall with ribs that enable fluid to flow around the ball when the valve is not closed.

To accommodate existing installation connection systems, the fluid inlet and fluid outlet sections may both be vertically oriented upon installation, with the end section of the fluid inlet being positioned above the end section of the fluid outlet section.

### BRIEF DESCRIPTION OF THE DRAWINGS

FIG. 1A is a cross section of a preferred embodiment of the invention

FIG. 1B is a section depicting details of a ball valve; and

FIG. 2 is an oblique, partially transparent view of an embodiment of the invention wherein the trap section includes a non-smooth or textured outer surface to assist a user in gripping and squeezing the trap section.

### DETAILED DESCRIPTION OF THE INVENTION

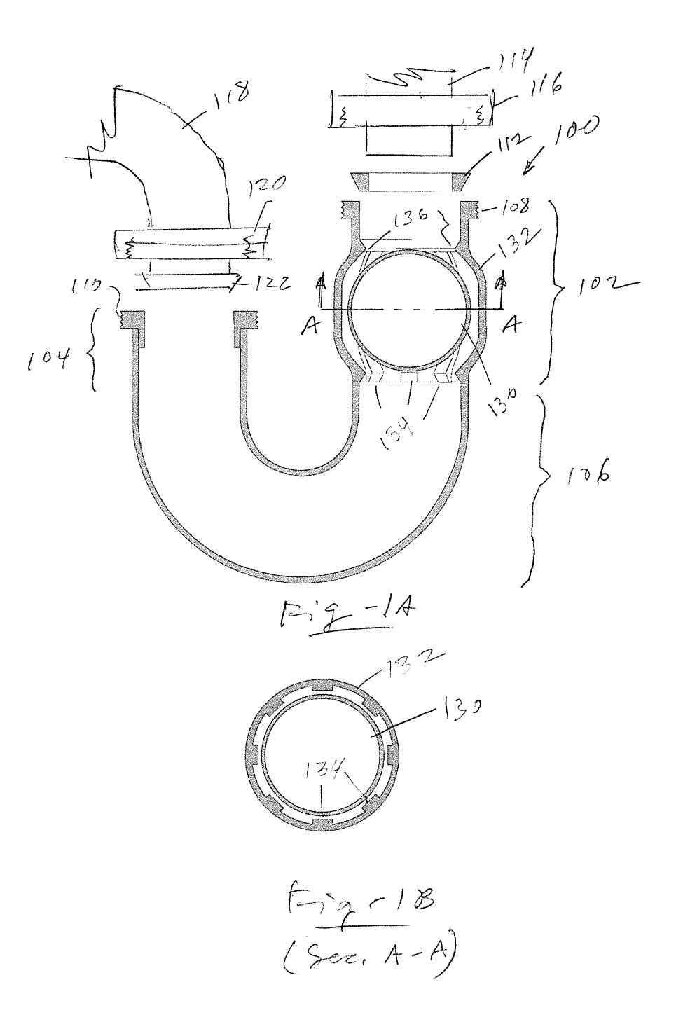

FIG. 1A is a cross section of a preferred embodiment of the invention. The device 100 generally comprises a bent tubular structure including a fluid inlet section 102, a fluid outlet section 104, and a U-shaped trap section 106 disposed between the fluid inlet and outlet sections. Both of the inlet and outlet sections terminate in respective end fittings 108, 110 facilitating connection to standard plumbing fixtures. For example, the diameter of the inlet end is preferably dimensioned to receive a washer 112 with an inside diameter to receive a “tail piece” 114 and compression nut 116. Likewise, fluid outlet section 104 preferably terminates in a threaded end 110 adapted to receive bent tubing 118 with flanged end 126 and compression nut 120 with threads to match threads 110 on the outlet end. Bent tubing 118 is typically a 90-degree tube that allows the fluid to exit horizontally to a coupling to a vertical drain line, for example. While the connection configuration just described is preferred for existing under-sink installations, the invention is not limited in this regard, so long as the unique combination of a compressible trap and one-way, back-flow-prevention, or “check” valve are provided as will now be described.

In accordance with the invention, the construction of the trap section 106 is such that it enables the trap section to be manually squeezed to dislodge unwanted materials and debris that might be clogging the trap section 106. In the preferred embodiment shown in FIG. 1A, with the exception of the threaded fitting 110 and ball 130, the entire bent tubular structure is composed of the same compressible, resilient material. Ring 110 is preferably composed of a more rigid material such as PVC and is frictionally fit, glued or otherwise bonded to fluid outlet section 104. Threaded ring 108 need not be as rigid, as its shape is maintained once installed over tailpiece 114. The use of a flexible, resilient material in the fluid inlet section also allows the ball 130 to be pressed into the ball housing as discussed further below.

The trap section may be made of a more rigid material such as PVC if the wall thickness is intentionally thinned to facilitate manual manipulation. However, in the preferred embodiments a more compressible, resilient material is used at least for the trap section. Indeed, the trap section may be composed of a material that is sufficiently flexible that the inner walls of the trap section may touch one another when that section of the trap is squeezed. Such materials at least include at least the following (though not in order of preference):

Coplyester

Copolyamide

TPU (Thermoplastic Polyurethane)

TPV (Thermoplastic Vulcanizate)

SBC (Styrene Block Copolymers)

TPO (Thermoplastic polyolefin elastomers)

Natural Rubber (Polyisoprene)

Polybutadiene rubber

Neoprene rubber

Butyl Rubber

Halogenated Butyl Rubber

Nitrile Rubber

Hydrogenated Nitrile rubber

PU (Thermoset Polyurethane rubber)

Silicone

TPSiV (Thermoplastic Silicone Vulcanizate)

EVA (Ethylene-vinyl acetate)

Fluorinated Silicone

Flouroeastomers

EPDM (Ethylene Propylene Diene Rubber)

Unique to this invention, a one-way, back-flow-prevention valve is disposed in the fluid inlet section. In operation, this valve permits fluid to flow into the fluid inlet section and through the trap section, while preventing fluid from flowing from the trap section and into the fluid inlet section as the trap section is manually squeezed. In the preferred embodiment the valve is a ball valve described in detail below. However, other types of one-way vales may alternatively be utilized, such as leaf or flap valves with any number of flaps. While the ball valve described herein conveniently relies on gravity in the open condition, biasing such as spring biasing may be used in conjunction with any desired valve type.

As mentioned, however, in the preferred embodiment a ball valve is used which includes ball 130 disposed in ball housing 132 which may constitute a bulbous section of the fluid inlet section. In the preferred embodiment, the housing includes an inner wall with ribs 134 that enable fluid to flow around the ball when the valve is not closed, and a circular seat 136 that the ball engages with under pressure to close the valve. FIG. 1B is a cross section of the ball 130, housing 132 and ribs 134, which may be more or fewer than the number shown in the drawings. The ball 130 is preferably hollow and may be similar in size and appearance to a common ping-pong ball.

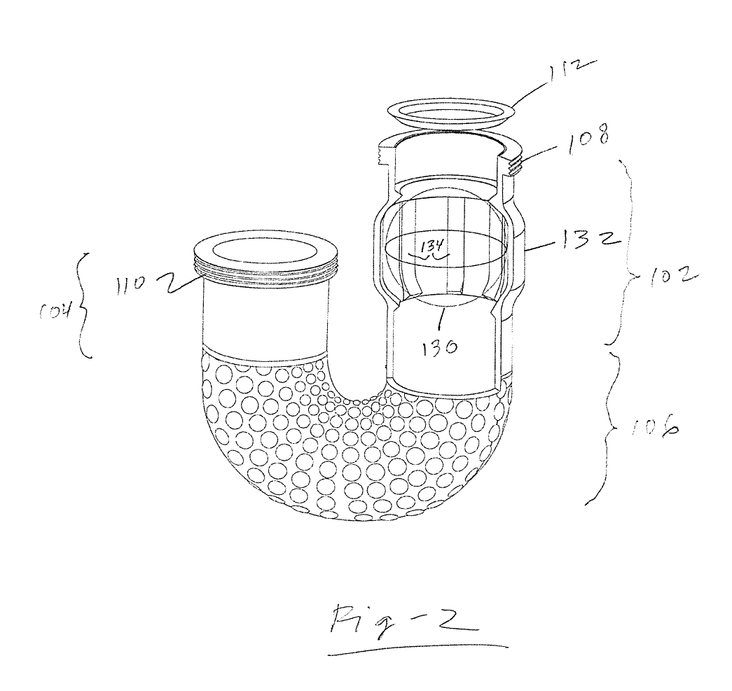

FIG. 2 illustrates an oblique, partially transparent view of an embodiment of the invention wherein the trap section includes a non-smooth or textured outer surface to assist a user in gripping and squeezing the trap section. Again, although the entire outer surface of the trap section is shown as being textured, a much smaller area may be non-smooth. For example, the trap section may be formed with two or more opposing button-like areas, or may include a flexible pleat. The combination of the buttons and the pleat allows the trap section 16 to be compressed inwardly by finger pressure on opposing buttons 18.

1. A manually cleanable drain trap, comprising:
a bent tubular structure including a fluid inlet section, a fluid outlet section, and a U-shaped trap section disposed between the fluid inlet and outlet sections;
wherein the construction of the trap section enables the trap section to be manually squeezed to dislodge unwanted materials clogging the trap section; and
a one-way valve disposed in the fluid inlet section, the one-way valve permitting fluid to flow into the fluid inlet section and through the trap section, while preventing back flow from the trap section and into the fluid inlet section as the trap section is manually squeezed.

2. The manually cleanable drain trap of claim 1, wherein the trap section has a wall thickness that is sufficiently thin to facilitate manual manipulation of the trap section.

3. The manually cleanable drain trap of claim 1, wherein the trap section is constructed from a compressible, resilient material.

4. The manually cleanable drain trap of claim 1, wherein the one-way valve disposed in the fluid inlet section is a ball valve.

5. The manually cleanable drain trap of claim 4, wherein:
the ball of the ball valve is disposed in a bulbous section in the fluid inlet portion; and
the bulbous section includes a circular seat that the ball engages with under pressure to close the valve.

6. The manually cleanable drain trap of claim 5, wherein the bulbous section includes an inner wall with ribs that enable fluid to flow around the ball when the valve is not closed.

7. The manually cleanable drain trap of claim 1, wherein the trap section includes a non-smooth, textured outer surface to assist a user in gripping and squeezing the trap section.

8. The manually cleanable drain trap of claim 1, wherein the fluid inlet section is vertically oriented upon installation.

9. The manually cleanable drain trap of claim 1, wherein the fluid outlet section is vertically oriented upon installation.

10. The manually cleanable drain trap of claim 1, wherein the fluid inlet and fluid outlet sections both terminate in end portions with fittings facilitating connection to existing plumbing fixtures.

11. The manually cleanable drain trap of claim 1, wherein:
both the fluid inlet and fluid outlet sections are vertically oriented upon installation; and
the end section of the fluid inlet is positioned above the end section of the fluid outlet section.

12. The manually cleanable drain trap of claim 1, wherein the fluid-inlet and trap sections of the bent, tubular structure are composed of the same compressible, resilient material.

13. A manually cleanable drain trap, comprising:
a bent tubular structure including a vertically oriented fluid inlet section, a vertically oriented fluid outlet section, and a U-shaped trap section disposed between the fluid inlet and outlet sections;
the trap section being composed of a compressible, resilient elastomeric or other material enabling the trap section to be manually squeezed to dislodge unwanted materials clogging the trap section;
a one-way valve disposed in the fluid inlet section, the one-way valve permitting fluid to flow into the fluid inlet section and through the trap section, while preventing back flow from the trap section and into the fluid inlet section as the trap section is manually squeezed;
wherein the fluid inlet and fluid outlet sections both terminate in end portions with fittings facilitating connection to existing plumbing fixtures; and
wherein the end section of the fluid inlet is positioned above the end section of the fluid outlet section when installed.

14. The manually cleanable drain trap of claim 13, wherein the one-way valve disposed in the fluid inlet section is a ball valve.

15. The manually cleanable drain trap of claim 14, wherein:
the ball of the ball valve is disposed in a bulbous section in the fluid inlet portion; and
the bulbous section includes a circular seat that the ball engages with under pressure to close the valve.

16. The manually cleanable drain trap of claim 15, wherein the bulbous section includes an inner wall with ribs that enable fluid to flow around the ball when the valve is not closed.

17. The manually cleanable drain trap of claim 13, wherein the trap section includes a non-smooth, textured outer surface to assist a user in gripping and squeezing the trap section.

18. The manually cleanable drain trap of claim 13, wherein the fluid-inlet and trap sections of the bent, tubular structure are composed of the same compressible, resilient material.

19. The manually cleanable drain trap of claim 18, further including a rigid or semi-rigid threaded fitting connected to the end of the fluid outlet section of the bent, tubular structure.
